(19) United States
(12) Patent Application Publication
(10) Pub. No.: US 2016/0019502 A1
(43) Pub. Date: Jan. 21, 2016

(54) SYSTEM FOR REVIEWING CUSTOMER INFORMATION

(71) Applicant: BANK OF AMERICA CORPORATION, CHARLOTTE, NC (US)

(72) Inventors: Raghavendran Narasimhan, Hyderabad (IN); Saurabh Bhatnagar, Gurgaon (IN); Pankaj Kumar, Gurgaon (IN); Monika V. Kapur, Gurgaon (IN)

(21) Appl. No.: 14/331,702

(22) Filed: Jul. 15, 2014

(51) Int. Cl. G06Q 10/10; G06F 17/30

(52) U.S. Cl. CPC G06Q 10/10; G06Q 40/02; G06F 17/30011

(57) ABSTRACT

Embodiments of the invention are directed to a system, method, and computer program product for reviewing customer information stored in a database. An exemplary embodiment includes retrieving multiple documents generated for a financial service provided to a customer from a financial institution database, wherein the retrieved documents include customer information. In response, the embodiment includes extracting the customer information from the retrieved documents for review. The extracted customer information is then compared with the information initially received from the customer to determine whether the generated documents have the correct customer information.

### BACKGROUND

A well-defined document management system can directly impact the efficiency and long-term health of a financial institution. Financial institutions provide a wide range of services such as investments, loans, deposits, or the like. With the increase in the number of services provided by the financial institution, the adoption of an efficient document management system has gained importance to enable financial institutions to provide seamless service to the customer.

Typically, internal document reviewing requires determining that information is consistency across multiple sources. There is a need for a system for efficient reviewing by identifying and eliminating non-value added steps to minimize the use of resources.

### BRIEF SUMMARY

Embodiments of the present invention address the above needs and/or achieve other advantages by providing apparatuses (e.g., a system, computer program product, and/or other device) and methods for pre-stage registration and check-in for use of remote video specialist system.

Embodiments of the present invention include systems, computer program products, and methods for reviewing customer information stored in a database, the invention comprising: receive information from a customer, wherein the information is associated with a financial institution service provided to the customer; generate one or more documents based on at least the financial institution service provided to the customer, wherein the one or more documents are generated based on at least the information received from the customer, wherein the one or more documents further comprises documents specific to the financial institution service provided to the customer; retrieve from the financial institution database, the one or more documents having customer information; extract customer information from the one or more retrieved documents; compare the customer information extracted from the one or more retrieved documents with the information received from the customer to determine a match; and validate the one or more documents based on at least determining the match between the information received from the customer and the customer information extracted from the one or more retrieved documents.

In some embodiments, to the invention includes reviewing the customer information to validate the one or more documents periodically.

In some embodiments, the invention includes determining whether adequate information has been received from the customer to enable the generation of the one or more documents, wherein the one or more documents are required to initiate the financial institution service.

In some embodiments, the system is further configured to enable a first user to generate the one or more documents and a second user to validate the one or more documents.

In some embodiments, the system is further configured to authenticate the first user based on authentication credentials received from the first user and authenticate the second user based on authentication credentials received from the second user.

In some embodiments, the system is further configured to initiate a presentation of a first user interface the second user, wherein the first user interface comprises an aggregation of the customer information extracted from the one or more generated documents.

In some embodiments, system is further configured to determine that the customer information extracted from the one or more retrieved documents does not match the information received from the customer; transmit a notification to the second user, wherein the notification comprises an option to rectify the mismatch between the customer information from the one or more retrieved documents and the information received from the customer; and update the one or more documents in the financial institution database based on at least the second user's rectification of the mismatch.

In some embodiments, the system is configured to extract customer information based on at least one of more fields in the one or more generated documents, wherein the one or more fields in the one or more generated documents match the one or more fields in the information received from the customer.

In one aspect, a method for reviewing customer information stored in a database is presented. The method comprises receiving, using a computing device, processor, information from a customer, wherein the information is associated with a financial institution service provided to the customer; generating, using a computing device processor, one or more documents based on at least the financial institution service provided to the customer, wherein the one or more documents are generated based on at least the information received from the customer, wherein the one or more documents further comprises documents specific to the financial institution service provided to the customer; retrieving, using a computing device processor, from the financial institution database, the one or more documents having customer information; extracting, using a computing device processor, customer information from the one or more retrieved documents; comparing, using a computing device processor, the customer information extracted from the one or more retrieved documents with the information received from the customer to determine a match; and validating, using a computing device processor, the one or more documents based on at least determining the match between the information received from the customer and the customer information extracted from the one or more retrieved documents.

In some embodiments, the method further comprises reviewing the customer information to validate the one or more documents periodically.

In some embodiments, validating further comprises, determining whether adequate information has been received from the customer to enable the generation of the one or more documents, wherein the one or more documents are required to initiate the financial institution service.

In some embodiments, generating further comprises enabling a first user to generate the one or more documents and a second user to validate the one or more documents.

In some embodiments, generating further comprises authenticating the first user based on authentication credentials received from the first user and authenticating the second user based on authentication credentials received from the second user.

In some embodiments, retrieving further comprises initiating a presentation of a first user interface the second user, wherein the first user interface comprises an aggregation of the customer information extracted from the one or more generated documents.

In some embodiments, retrieving further comprises determining, using a computing device processor, that the customer information extracted from the one or more retrieved documents does not match the information received from the customer; transmitting, using a computing device processor, a notification to the second user, wherein the notification comprises an option to rectify the mismatch between the customer information from the one or more retrieved documents and the information received from the customer; and updating, using a computing device processor, the one or more documents in the financial institution database based on at least the second user's rectification of the mismatch.

In some embodiments, retrieving further comprises extracting customer information based on at least one of more fields in the one or more generated documents, wherein the one or more fields in the one or more generated documents match the one or more fields in the information received from the customer.

In another aspect, a computer program product for reviewing customer information stored in a database is presented. The computer program product comprises a non-transitory computer-readable medium comprising code causing a first apparatus to receive information from a customer, wherein the information is associated with a financial institution service provided to the customer; generate one or more documents based on at least the financial institution service provided to the customer, wherein the one or more documents are generated based on at least the information received from the customer, wherein the one or more documents further comprises documents specific to the financial institution service provided to the customer; retrieve from the financial institution database, the one or more documents having customer information; extract customer information from the one or more retrieved documents; compare the customer information extracted from the one or more retrieved documents with the information received from the customer to determine a match; and validate the one or more documents based on at least determining the match between the information received from the customer and the customer information extracted from the one or more retrieved documents.

In some embodiments, the first apparatus is further configured to receive from the customer, information associated with the financial institution service provided to the customer; generate one or more documents based on at least the financial institution service provided to the customer, wherein the one or more documents are generated based on at least the information received from the customer; and store the one or more documents in the financial institution database.

In some embodiments, the first apparatus is further configured to determine whether adequate information has been received from the customer to enable the generation of the one or more documents, wherein the one or more documents are required to initiate the financial institution service.

In some embodiments, the first apparatus is further configured to enable a first user to generate the one or more documents and a second user to validate the one or more documents.

### BRIEF DESCRIPTION OF THE DRAWINGS

Having thus described embodiments of the invention in general terms, reference will now be made to the accompanying drawings, where:

FIG. 1 presents a process flow for reviewing customer information in accordance with an embodiment of the present invention.

FIG. 2 presents a process flow for generating one or more documents based on customer information in accordance with another embodiment of the present invention.

FIG. 3 presents a process flow for updating one or more documents in the financial institution database in accordance with another embodiment of the present invention.

FIG. 4 presents an exemplary interface for a user to review the customer information extracted from the one or more generated documents.

FIG. 5 presents an exemplary block diagram of the system environment.

FIG. 6 illustrates an exemplary process flow for a system for reviewing customer information.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a customer to establish an account with the entity. An “account” may be the relationship that the customer has with the entity. Examples of accounts include a deposit account, such as a transactional account (e.g. a banking account), a savings account, an investment account, a money market account, a time deposit, a demand deposit, a pre-paid account, a credit account, a non-monetary customer profile that includes only personal information associated with the customer, or the like. The account is associated with and/or maintained by an entity. In other embodiments, an “entity” may not be a financial institution.

In some embodiments, a “customer” may be a financial institution customer (e.g., an account holder or a person who have an account (e.g., banking account, credit account, or the like)). In some other embodiments, a customer may not be associated with the financial institution. In some embodiments, an “employee” may be a financial institution employee (e.g., an underwriter, a project manager, an information technology specialist, a manager, an administrator, an internal operations analyst, bank teller, or the like). In one aspect, an employee may be capable of facilitating a transaction between the entity and a customer. For purposes of the present invention, an employee in a business environment (e.g. financial institution) may be considered as the “user” of the system, method, and computer program product described herein.

Recently, document management systems have become indispensable for many organizations. The majority of the organizations need to access and consult stored customer information frequently. Thus, efficiency requirements must be considered by the document management systems in order to provide fast and accurate access to customer information. Furthermore, documents need to pass from one person to another in many of these organizations. Organizations continue to search for new methods to improve document management systems. Many are exploring elegant, cost-effective, automated solutions to help manage documents to enable users to spend less time creating, filing, retrieving, and reviewing documents. By implementing an efficient system to manage documents, organizations can realize many benefits that noticeably improve organizational efficiency. The present invention is directed to a system for reviewing customer information to enable the user to manage documents efficiently, meet the turnaround expectation consistently, and reduce the amount of time spent in executing the process by removing non-value added steps.

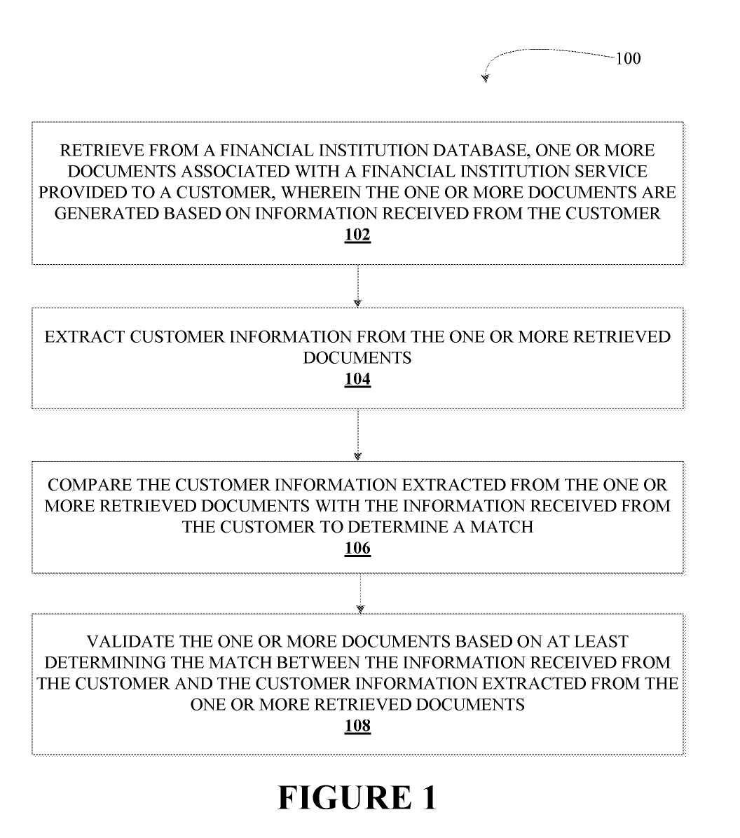

FIG. 1 illustrates a process flow for reviewing customer information in accordance with an embodiment of the present invention 100. As shown in block 102, the process flow includes retrieving from a financial institution database, one or more documents associated with a financial institution service provided to a customer, wherein the one or more documents are generated based on at least information received from the customer. Typically, financial institutions provide a wide range of comprehensive financial services including but not limited to treasury management, credit services, foreign exchange, loan/mortgage, investment banking, financial account services, or the like. In some embodiments, providing a comprehensive service to a customer may include receiving information associated with the customer. Typically, the customer information may include one or more fields. In one aspect, the one or more fields may include identity data, quantitative data, descriptive data, and qualitative data. In some embodiments, identity data may include personal information such as name information, postal address information, career information, or the like. In some other embodiments, quantitative data may include financial information, social network activity information, or the like. In yet another embodiment, descriptive data may include family information, lifestyle details, asset information, or the like. In yet another embodiment, qualitative data may include an assessment of the customer interaction based on questionnaire type information where attitude, motivation, and opinion are provided.

In response to receiving the information from the customer, the system may be configured to enable a financial institution employee to generate one or more documents associated with the financial institution service provided to the customer. For example, a customer may be involved in a loan/mortgage process with the financial institution. In this regard, the financial institution may require the customer to execute several loan/mortgage documents such as a loan agreement, security agreement, guarantee, disbursement and fee statement, or the like. Once the loan/mortgage documents are executed by the customer, the system may be configured to enable a financial institution employee to generate re-payment, interest, fee schedules, or the like based on the received information. The generated one or more documents are then stored in a financial institution database for further use. In some embodiments, the process flow includes determining whether adequate information has been received from the customer to enable the generation of one or more documents to ensure the initiation of the financial institution service.

As shown in block 104, the process flow includes extracting customer information from the one or more retrieved documents. In this way, the system may be configured to enable an employee to perform a comprehensive analysis of the customer information based on the information extracted from the retrieved documents. A comprehensive analysis may enable a financial institution employee to avoid manually reviewing each of the one or more retrieved documents individually to determine whether the information received from the customer is consistent with the customer information extracted from the one or more retrieved documents. In some embodiments, the comprehensive analysis may include an aggregation of the customer information extracted to be presented to a financial institution employee on the same interface. In some embodiments, extracting customer information from the one or more retrieved documents may require one or more authentication credentials from the customer. In one aspect, the customer information is extracted based on at least one of more fields in the retrieved documents, wherein the one or more fields in the retrieved documents match the one or more fields in the information received from the customer.

Once the customer information is extracted, the process flow includes comparing the customer information extracted from the one or more retrieved documents with the information received from the customer to determine a match, as shown in block 106. During the reviewing process, a financial institution employee may be assigned with the responsibility of ensuring that the information provided by the customer is consistent with the customer information in the one or more documents generated (e.g., assessment schedules). In some embodiments, the financial institution employee who generated the one or more documents may be different from the financial institution employee reviewing the one or more documents. In another embodiment, the financial institution employee who generated the one or more documents may be the same financial institution employee reviewing the one or more documents.

In response, the process flow includes validating the one or more documents based on at least determining the match between the information received from the customer and the customer information extracted from the one or more retrieved documents, as shown in block 108. In some embodiments, the system may be configured to review the customer information periodically (e.g. daily, weekly, monthly, or the like).

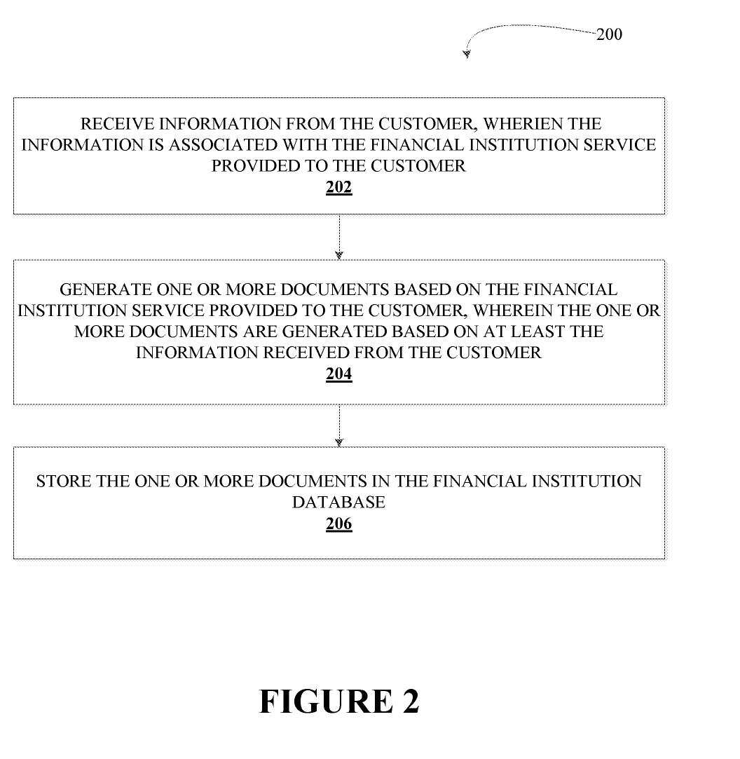

FIG. 2 illustrates a process flow for generating one or more documents based on customer information in accordance with another embodiment of the present invention 200. As shown in block 202, the process flow includes receiving information from the customer, wherein the information is associated with the financial institution service provided to the customer. In response, the process flow includes generating one or more documents based on at least the financial institution service provided to the customer, wherein the one or more documents are generated based on at least the information received from the customer, as shown in block 204. Once the one or more documents are generated by the financial institution employee, the process flow includes storing the one or more documents in a financial institution database, as shown in block 206.

In one aspect, the one or more documents generated include one or more fields. In some embodiments, the extraction of customer information from the one of more documents may be based on at least matching the one or more fields in the one or more documents with the one or more fields in the information received from the customer. For example, the one or more fields in the information received from the customer may include financial institution checking account number, personal information, security information, or the like. In some embodiments, when a financial institution employee generates one or more documents for a loan/mortgage service provided to the customer, the one or more documents may include at least one of the fields included in the information received from the customer. For example, if there are four documents generated by the financial institution employee, the first document may include the customer's financial institution checking account number and personal information, and the fourth document may include the customer's security information and the personal information. In such situations, the system may be configured to not only enable the financial institution employee to determine whether the customer information extracted from the one or more documents are consistent with the information received from the customer, but also determine whether the customer information extracted from the one or more documents are consistent with each other. Based on the previous example, the system may be configured to enable the financial institution employee determine whether the personal information extracted from the first document generated is consistent with the personal information extracted from the fourth document.

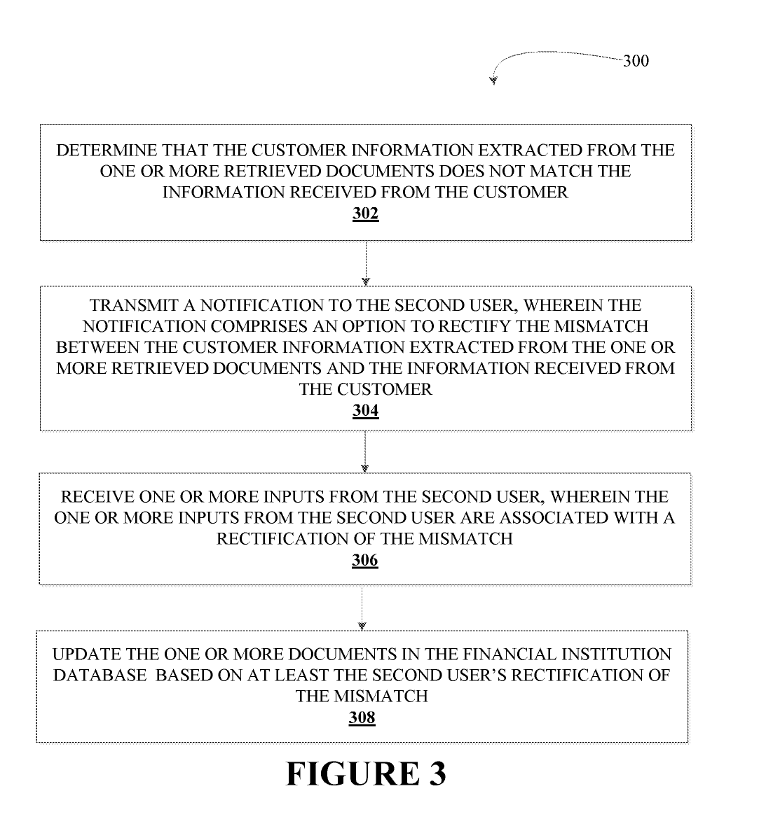

FIG. 3 illustrates a process flow for updating one or more documents in the financial institution database in accordance with another embodiment of the present invention 300. As shown in block 302, the process flow includes determining that the customer information extracted from the one or more retrieved documents does not match the information received from the customer. In response, the process flow includes transmitting a notification to the second user, wherein the notification comprises an option to rectify the mismatch between the customer information extracted from the one or more generated documents and information received from the customer, as shown in block 304. In response, the process flow includes receiving one or more inputs from the second user, wherein the one or more inputs from the second user are associated with a rectification of the mismatch, as shown in block 306.

In some embodiments, the system may be configured to determine that the customer information extracted from the one or more retrieved documents does not match the information received from the customer based on at least comparing the information received from the customer and the customer information extracted from the one or more retrieved documents. In another embodiment, the system may be configured to determine that the customer information extracted from at least one of the one or more retrieved document does not match the customer information extracted from another document from the one or more retrieved documents.

In one aspect, the system may be configured to initiate the presentation of a user interface to a financial institution employee with one or more identified mismatches. In some embodiments, the interface may include one or more suggestions to the financial institution employee based on at least comparing the information received from the customer with the customer information extracted from the one or more retrieved documents. For example, the user interface may determine that a customer's name (personal information) as received from the customer states “Customer 1” while customer information extracted from the one or more documents retrieved states “Customer 2”. In such situation, the system may be configured to notify the financial institution employee of the mismatch of the customer's name, as well as prompt a suggestion to the financial institution employee based on at least the information received from the customer.

In some embodiments, the system may be configured to update the rectified customer information consistently across all of the one or more retrieved documents. In some other embodiments, the system may enable the financial institution employee to choose at least one of the one or more retrieved documents to update the rectified customer information.

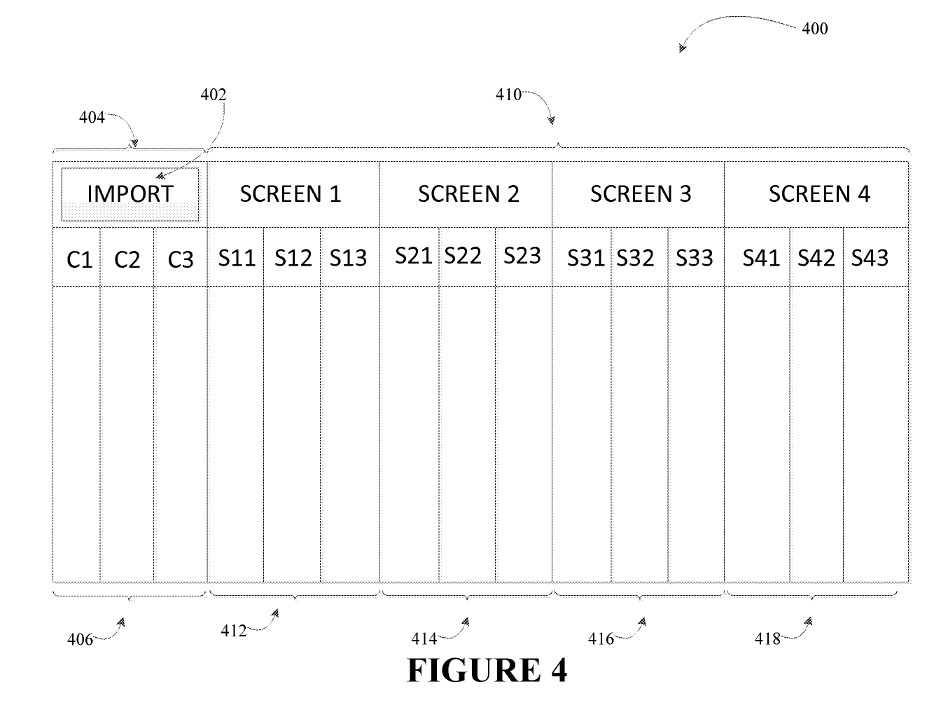

FIG. 4 presents an exemplary interface for a financial institution employee to review the customer information extracted from the one or more retrieved documents 400. As shown in 500, the interface includes and input field 404, and an output field 410. In some embodiments, the input field 404 comprises an import option 402, and one or more customer information fields 406 (C1, C2, and C3). In some other embodiment, the output field 410 comprises one or more generated documents SCREEN 1 412, SCREEN 2 414, SCREEN 3 416, and SCREEN 4 418, wherein each of the one or more retrieved documents include one or more fields. For example, document SCREEN 1 may include fields S11, S12, S13, document SCREEN 2 may include fields S21, S22, S23, document SCREEN 3 may include fields S31, S32, S33, and document SCREEN 4 may include fields S41, S42, S43.

In some embodiments, a financial institution employee may retrieve one or more documents from the financial institution database and import customer information from the one or more retrieved documents using the import option 402. In one aspect, the system may be configured to enable the financial institution employee import the one or more generated documents based on a customer identifier. In some embodiments, when the customer executes one or more documents associated with a financial institution service, the customer may be assigned an identifier. In one aspect, the identifier may be a global identifier known to both the financial institution and the customer. In another aspect, the identifier may be a local/internal identifier known only to the financial institution. In some embodiments, the system may be configured to enable the financial institution employee import customer information based on at least matching one customer information field 406.

In some embodiments, the customer information extracted using the import option 402 may be aggregated as shown in FIG. 400 and presented to the financial institution employee. In one aspect, the system may enable a financial institution employee to review and determine whether the information received from the customer is consistent with the customer information extracted from the one or more retrieved documents and/or determine whether the customer information extracted from the one or more retrieved documents are consistent with each other.

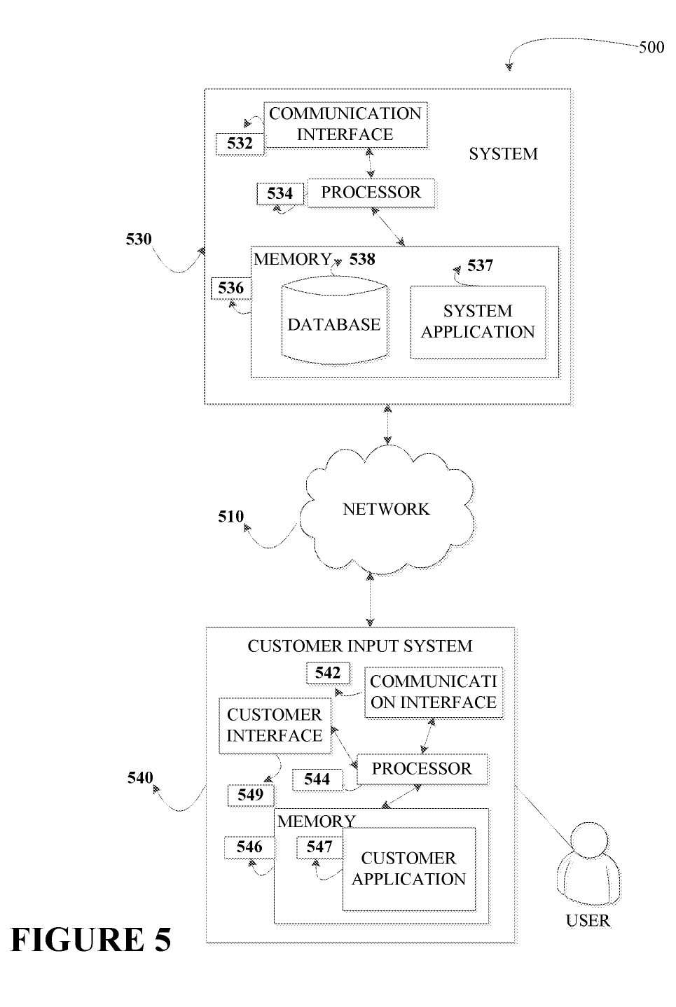

FIG. 5 presents an exemplary block diagram of the system environment 500 for implementing the process flows described herein in accordance with embodiments of the present invention. As illustrated, the system environment 500 includes a network 510, a system 530, and a user input system 540. Also shown in FIG. 5 is a user of the user input system 540. The user input system 540 may be a mobile device or other non-mobile computing device. The user may be a person who uses the user input system 540 to execute a user application 547. The user application 547 may be an application to communicate with the system 530, perform a transaction, input information onto a user interface presented on the user input system 540, or the like. The user application 547 and/or the system application 537 may incorporate one or more parts of any process flow described herein.

As shown in FIG. 5, the system 530, and the user input system 540 are each operatively and selectively connected to the network 510, which may include one or more separate networks. In addition, the network 510 may include a telecommunication network, local area network (LAN), a wide area network (WAN), and/or a global area network (GAN), such as the Internet. It will also be understood that the network 510 may be secure and/or unsecure and may also include wireless and/or wired and/or optical interconnection technology.

The user input system 540 may include any computerized apparatus that can be configured to perform any one or more of the functions of the user input system 540 described and/or contemplated herein. For example, the user may use the user input system 540 to transmit and/or receive information or commands to and from the system 530. In some embodiments, for example, the user input system 540 may include a personal computer system (e.g. a non-mobile or non-portable computing system, or the like), a mobile computing device, a personal digital assistant, a mobile phone, a tablet computing device, a network device, and/or the like. As illustrated in FIG. 5, in accordance with some embodiments of the present invention, the user input system 540 includes a communication interface 542, a processor 544, a memory 546 having an user application 547 stored therein, and a user interface 549. In such embodiments, the communication interface 542 is operatively and selectively connected to the processor 544, which is operatively and selectively connected to the user interface 549 and the memory 546. In some embodiments, the user may use the user application 547 to execute processes described with respect to the process flows described herein. Specifically, the user application 547 executes the process flows described herein.

Each communication interface described herein, including the communication interface 542, generally includes hardware, and, in some instances, software, that enables the user input system 540, to transport, send, receive, and/or otherwise communicate information to and/or from the communication interface of one or more other systems on the network 510. For example, the communication interface 542 of the user input system 540 may include a wireless transceiver, modem, server, electrical connection, and/or other electronic device that operatively connects the user input system 540 to another system such as the system 530. The wireless transceiver may include a radio circuit to enable wireless transmission and reception of information. Additionally, the user input system 540 may include a positioning system. The positioning system (e.g. a global positioning system (GPS), a network address (IP address) positioning system, a positioning system based on the nearest cell tower location, or the like) may enable at least the user input system 540 or an external server or computing device in communication with the user input system 540 to determine the location (e.g. location coordinates) of the user input system 540.

Each processor described herein, including the processor 544, generally includes circuitry for implementing the audio, visual, and/or logic functions of the user input system 540. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 547 of the memory 546 of the user input system 540.

Each memory device described herein, including the memory 546 for storing the user application 547 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 546 includes the user application 547. In some embodiments, the user application 547 includes an interface for communicating with, navigating, controlling, configuring, and/or using the user input system 540. In some embodiments, the user application 547 includes computer-executable program code portions for instructing the processor 544 to perform one or more of the functions of the user application 547 described and/or contemplated herein. In some embodiments, the user application 547 may include and/or use one or more network and/or system communication protocols.

Also shown in FIG. 5 is the user interface 549. In some embodiments, the user interface 549 includes one or more output devices, such as a display and/or speaker, for presenting information to the user. In some embodiments, the user interface 549 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 549 includes the input and display devices of a mobile device, which are operable to receive and display information.

FIG. 5 also illustrates a system 530, in accordance with an embodiment of the present invention. The system 530 may refer to the “apparatus” described herein. The system 530 may include any computerized apparatus that can be configured to perform any one or more of the functions of the system 530 described and/or contemplated herein. In accordance with some embodiments, for example, the system 530 may include a computer network, an engine, a platform, a server, a database system, a front end system, a back end system, a personal computer system, and/or the like. Therefore, the system 530 may be a server managed by the entity. The system 530 may be located at the facility associated with the entity or remotely from the facility associated with the entity. In some embodiments, such as the one illustrated in FIG. 5, the system 530 includes a communication interface 532, a processor 534, and a memory 536, which includes a system application 537 and a structured database 538 stored therein. As shown, the communication interface 532 is operatively and selectively connected to the processor 534, which is operatively and selectively connected to the memory 536.

It will be understood that the system application 537 may be configured to implement any one or more portions of the various user interfaces and/or process flow described herein. The system application 537 may interact with the user application 547. It will also be understood that, in some embodiments, the memory includes other applications. It will also be understood that, in some embodiments, the system application 537 is configured to communicate with the structured database 538, the user input system 540, or the like.

It will be further understood that, in some embodiments, the system application 537 includes computer-executable program code portions for instructing the processor 534 to perform any one or more of the functions of the system application 537 described and/or contemplated herein. In some embodiments, the system application 537 may include and/or use one or more network and/or system communication protocols.

In addition to the system application 537, the memory 536 also includes the structured database 538. As used herein, the structured database 538 may be one or more distinct and/or remote databases. In some embodiments, the structured database 538 is not located within the system and is instead located remotely from the system. In some embodiments, the structured database 538 stores information or data described herein.

It will be understood that the structured database 538 may include any one or more storage devices, including, but not limited to, datastores, databases, and/or any of the other storage devices typically associated with a computer system. It will also be understood that the structured database 538 may store information in any known way, such as, for example, by using one or more computer codes and/or languages, alphanumeric character strings, data sets, figures, tables, charts, links, documents, and/or the like. Further, in some embodiments, the structured database 538 may include information associated with one or more applications, such as, for example, the system application 537. It will also be understood that, in some embodiments, the structured database 538 provides a substantially real-time representation of the information stored therein, so that, for example, when the processor 534 accesses the structured database 538, the information stored therein is current or substantially current.

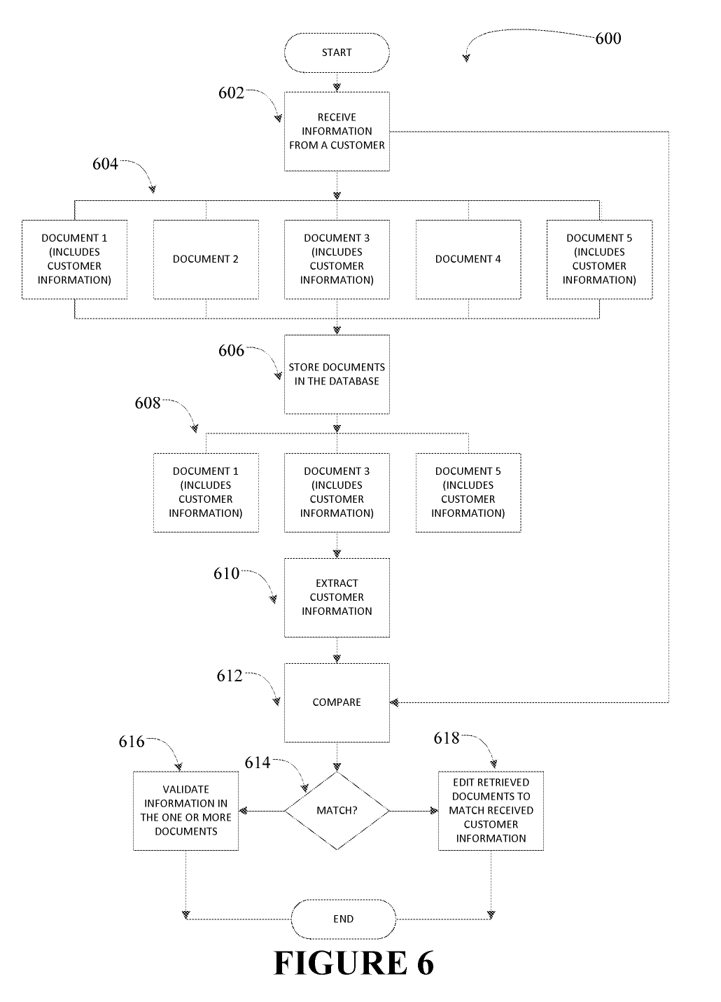

FIG. 6 illustrates an exemplary process flow for a system for reviewing customer information, 600. As shown in block 602, the system may be configured to receive information from a customer. In one aspect, the information received from the customer may be based on the financial institution service provided to the customer. In response, the system may be configured to generate one or more documents, as shown in block set 604. In one aspect, a portion of the one or more documents generated may have customer information. As shown in the Figure, document 1, document 3, and document 5 have customer information. In response, the one or more generated documents may be stored in a financial institution database, as shown in block 606. In some embodiments, the system may be configured to retrieve one or more documents having customer information from the financial institution database, as shown in block set 608. The system may then extract customer information from the retrieved one or more documents and compare 612 the extracted customer information 610 with the received customer information, as shown in block 614 to determine a match. If the customer information extracted from the retrieved one or more documents and the received customer information match, the system may validate the information, as shown in block 616. If the customer information extracted from the retrieved one or more documents and the received customer information do not match, the system may then edit the information to ensure that they match and store the one or more edited documents in the financial institution database, as shown in block 618.

It will be understood that the embodiment of the system environment illustrated in FIG. 5 is exemplary and that other embodiments may vary. As another example, in some embodiments, the system 530 includes more, less, or different components. As another example, in some embodiments, some or all of the portions of the system environment 500 may be combined into a single portion. Likewise, in some embodiments, some or all of the portions of the system 530 may be separated into two or more distinct portions.

In addition, the various portions of the system environment 500 may be maintained for and/or by the same or separate parties. It will also be understood that the system 530 may include and/or implement any embodiment of the present invention described and/or contemplated herein. For example, in some embodiments, the system 530 is configured to implement any one or more of the embodiments of the process flows described and/or contemplated herein in connection any process flow described herein. Additionally, the system 530 or the user input system 540 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for reviewing customer information stored in a database, the system comprising:
a memory device with computer-readable program code stored hereon;
a communication device;
a processing device operatively coupled to the memory device and the communication device, wherein the processing device is configured to execute the computer-readable program code to:
receive information from a customer, wherein the information is associated with a financial institution service provided to the customer;
generate one or more documents based on at least the financial institution service provided to the customer, wherein the one or more documents are generated based on at least the information received from the customer, wherein the one or more documents further comprises documents specific to the financial institution service provided to the customer;
retrieve from the financial institution database, the one or more documents having customer information;
extract customer information from the one or more retrieved documents;
compare the customer information extracted from the one or more retrieved documents with the information received from the customer to determine a match; and
validate the one or more documents based on at least determining the match between the information received from the customer and the customer information extracted from the one or more retrieved documents.

2. The system of claim 1, wherein the processing device is further configured to review the customer information to validate the one or more documents periodically.

3. The system of claim 1, wherein the processing device is further configured to determine whether adequate information has been received from the customer to enable the generation of the one or more documents, wherein the one or more documents are required to initiate the financial institution service.

4. The system of claim 1, wherein the processing device is further configured to enable a first user to generate the one or more documents and a second user to validate the one or more documents.

5. The system of claim 4, wherein the processing device is further configured to authenticate the first user based on authentication credentials received from the first user and authenticate the second user based on authentication credentials received from the second user.

6. The system of claim 4, wherein the processing device is further configured to initiate a presentation of a first user interface the second user, wherein the first user interface comprises an aggregation of the customer information extracted from the one or more generated documents.

7. The system of claim 4, wherein processing device is further configured to:
determine that the customer information extracted from the one or more retrieved documents does not match the information received from the customer;
transmit a notification to the second user, wherein the notification comprises an option to rectify the mismatch between the customer information from the one or more retrieved documents and the information received from the customer; and
update the one or more documents in the financial institution database based on at least the second user's rectification of the mismatch.

8. The system of claim 1, wherein the processing device is configured to extract customer information based on at least one of more fields in the one or more generated documents, wherein the one or more fields in the one or more generated documents match the one or more fields in the information received from the customer.

9. A method for reviewing customer information stored in a database, the method comprising:
receiving, using a computing device, processor, information from a customer, wherein the information is associated with a financial institution service provided to the customer;
generating, using a computing device processor, one or more documents based on at least the financial institution service provided to the customer, wherein the one or more documents are generated based on at least the information received from the customer, wherein the one or more documents further comprises documents specific to the financial institution service provided to the customer;
retrieving, using a computing device processor, from the financial institution database, the one or more documents having customer information;
extracting, using a computing device processor, customer information from the one or more retrieved documents;
comparing, using a computing device processor, the customer information extracted from the one or more retrieved documents with the information received from the customer to determine a match; and
validating, using a computing device processor, the one or more documents based on at least determining the match between the information received from the customer and the customer information extracted from the one or more retrieved documents.

10. The method of claim 9, wherein the method further comprises reviewing the customer information to validate the one or more documents periodically.

11. The method of claim 9, wherein validating further comprises, determining whether adequate information has been received from the customer to enable the generation of the one or more documents, wherein the one or more documents are required to initiate the financial institution service.

12. The method of claim 9, wherein generating further comprises enabling a first user to generate the one or more documents and a second user to validate the one or more documents.

13. The method of claim 12, wherein generating further comprises authenticating the first user based on authentication credentials received from the first user and authenticating the second user based on authentication credentials received from the second user.

14. The method of claim 12, wherein retrieving further comprises initiating a presentation of a first user interface the second user, wherein the first user interface comprises an aggregation of the customer information extracted from the one or more generated documents.

15. The method of claim 12, wherein retrieving further comprises:
determining, using a computing device processor, that the customer information extracted from the one or more retrieved documents does not match the information received from the customer;
transmitting, using a computing device processor, a notification to the second user, wherein the notification comprises an option to rectify the mismatch between the customer information from the one or more retrieved documents and the information received from the customer; and
updating, using a computing device processor, the one or more documents in the financial institution database based on at least the second user's rectification of the mismatch.

16. The method of claim 9, wherein retrieving further comprises extracting customer information based on at least one of more fields in the one or more generated documents, wherein the one or more fields in the one or more generated documents match the one or more fields in the information received from the customer.

17. A computer program product for reviewing customer information stored in a database, the computer program product comprising a non-transitory computer-readable medium comprising code causing a first apparatus to:
receive information from a customer, wherein the information is associated with a financial institution service provided to the customer;
generate one or more documents based on at least the financial institution service provided to the customer, wherein the one or more documents are generated based on at least the information received from the customer, wherein the one or more documents further comprises documents specific to the financial institution service provided to the customer;
retrieve from the financial institution database, the one or more documents having customer information;
extract customer information from the one or more retrieved documents;
compare the customer information extracted from the one or more retrieved documents with the information received from the customer to determine a match; and
validate the one or more documents based on at least determining the match between the information received from the customer and the customer information extracted from the one or more retrieved documents.

18. The computer program product of claim 17, wherein the first apparatus is further configured to review the customer information to validate the one or more documents periodically.

19. The computer program product of claim 17, wherein the first apparatus is further configured to determine whether adequate information has been received from the customer to enable the generation of the one or more documents, wherein the one or more documents are required to initiate the financial institution service.

20. The computer program product of claim 17, wherein the first apparatus is further configured to enable a first user to generate the one or more documents and a second user to validate the one or more documents.
